(19) United States
(12) Patent Application Publication
(10) Pub. No.: US 2024/0349317 A1
(43) Pub. Date: Oct. 17, 2024

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Satoshi Nagata, Tokyo (JP); Jing Wang, Beijing (CN); Lan Chen, Beijing (CN)

(73) Assignee: NTT DOCOMO, INC., Tokyo (JP)

(21) Appl. No.: 18/683,428

(22) PCT Filed: Aug. 17, 2022
(86) PCT No.: PCT/JP2022/031030

§ 371 Date: Feb. 13, 2024

(30) Foreign Application Priority Data
Aug. 23, 2021 (JP) 2021-135503

(51) Int. Cl. H04W 72/50; H04W 74/0833

(52) U.S. Cl. CPC H04W 72/50; H04W 74/0833

(57) ABSTRACT

Beam failure detection or beam failure recovery is appropriately performed even when a plurality of transmission/reception points is used. A terminal according to an aspect of the present disclosure includes a receiving section that receives information regarding a detection unit of a beam failure corresponding to each of one or more cells, and a control section that controls transmission of a medium access control control element (MAC CE) including a field indicating a beam failure in a cell unit or a transmission/reception point at which a beam failure is detected based on the detection unit of the beam failure of a corresponding cell.

### TECHNICAL FIELD

The present disclosure relates to a terminal, a radio communication method, and a base station in a next-generation mobile communication system.

### BACKGROUND ART

In the universal mobile telecommunications system (UMTS) network, the specifications of long term evolution (LTE) have been drafted for the purpose of further increasing high speed data rates, providing lower delays, and the like (see Non Patent Literature 1). Further, the specifications of LTE-Advanced (third generation partnership project (3GPP) Release (Rel.) 10 to 14) have been drafted for the purpose of further increasing capacity and advancement of LTE (3GPP Rel. 8 and 9), and the like.

Successor systems to LTE (for example, also referred to as 5th generation mobile communication system (5G), 5G+ (plus), 6th generation mobile communication system (6G), New Radio (NR), 3GPP Rel. 15 and subsequent releases, and the like) have also been studied.

In existing LTE systems (LTE Rel. 8 to 15), radio link quality is monitored (radio link monitoring (RLM)). When a radio link failure (RLF) is detected by RLM, re-establishment of radio resource control (RRC) connection is requested of the user terminal (user equipment (UE)).

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

In future radio communication systems (for example, NR), it has been studied to perform a procedure to detect a beam failure and switch to another beam (which may also be referred to as a beam failure recovery (BFR) procedure, BFR, link recovery procedures, and the like).

Further, in Rel. 17 NR and subsequent releases, it is also assumed that a terminal (UE) performs communication using a plurality of transmission/reception points (TRP)/UE panels. In this case, it is conceivable to perform beam failure detection in a plurality of TRPs/a plurality of UE panels, but how to control beam failure detection (BFD) or beam failure recovery (BFR) in each TRP/UE panel becomes a problem. If beam failure detection or beam failure recovery in each TRP/UE panel cannot be properly controlled, communication throughput may decrease or communication quality may deteriorate.

The present disclosure has been made in view of such a point, and an object of the present disclosure is to provide a terminal, a radio communication method, and a base station which enable appropriate beam failure detection or beam failure recovery even when a plurality of transmission/reception points is used.

### Solution to Problem

A terminal according to an aspect of the present disclosure includes a receiving section that receives information regarding a detection unit of a beam failure corresponding to each of one or more cells, and a control section that controls transmission of a medium access control control element (MAC CE) including a field indicating a beam failure in a cell unit or a transmission/reception point at which a beam failure is detected based on the detection unit of the beam failure of a corresponding cell.

### Advantageous Effects of Invention

According to an aspect of the present disclosure, beam failure detection or beam failure recovery can be appropriately performed even when a plurality of transmission/reception points is used.

### BRIEF DESCRIPTION OF DRAWINGS

FIG. 1 is a diagram illustrating an example of a beam recovery procedure in Rel. 15 NR.

FIGS. 2A and 2B are diagrams illustrating a configuration of a BFR MAC CE before Rel. 16.

FIGS. 3A to 3C are diagrams illustrating an example of a case where BFR configuration/beam failure detection units are separately configured between cells.

FIG. 4 is a diagram illustrating an example of a MAC CE configuration usable in the BFR procedure according to a first embodiment.

FIG. 5 is a diagram illustrating an example of the MAC CE configuration including a field (for example, for a cell) indicating a cell.

FIG. 6 is a diagram illustrating another example of the MAC CE configuration usable in the BFR procedure according to the first embodiment.

FIGS. 7A to 7C are diagrams illustrating an example of a MAC CE configuration usable in a BFR procedure according to a second embodiment.

FIGS. 8A to 8C are diagrams illustrating another example of the MAC CE configuration usable in the BFR procedure according to the second embodiment.

FIG. 9 is a diagram illustrating an example of a schematic configuration of a radio communication system according to one embodiment.

FIG. 10 is a diagram illustrating an example of a configuration of a base station according to one embodiment.

FIG. 11 is a diagram illustrating an example of a configuration of a user terminal according to one embodiment.

FIG. 12 is a diagram illustrating an example of a hardware configuration of the base station and the user terminal according to one embodiment.

### DESCRIPTION OF EMBODIMENTS

### (Beam Failure Detection)

In NR, communication is performed using beam forming. For example, a UE and a base station (for example, gNodeB (gNB)) may use a beam used for signal transmission (which is also referred to as a transmission beam, a Tx beam, or the like) or a beam used for signal reception (which is also referred to as a reception beam, an Rx beam, or the like).

In a case where beam forming is used, degradation of radio link quality is assumed because it becomes susceptible to interference by an obstacle. A radio link failure (RLF) may frequently occur due to degradation of the radio link quality. When the RLF occurs, cell re-connection is required, and thus frequent occurrence of the RLF leads to degradation of system throughput.

In the NR, to suppress the occurrence of the RLF, a procedure of switching to another beam (which may also be referred to as beam recovery (BR), beam failure recovery (BFR), Layer 1/Layer 2 (L1/L2) beam recovery, or the like) is performed in a case where quality of a specific beam is degraded. Note that the BFR procedure may be simply referred to as BFR.

Note that a beam failure (BF) in the present disclosure may also be referred to as a link failure.

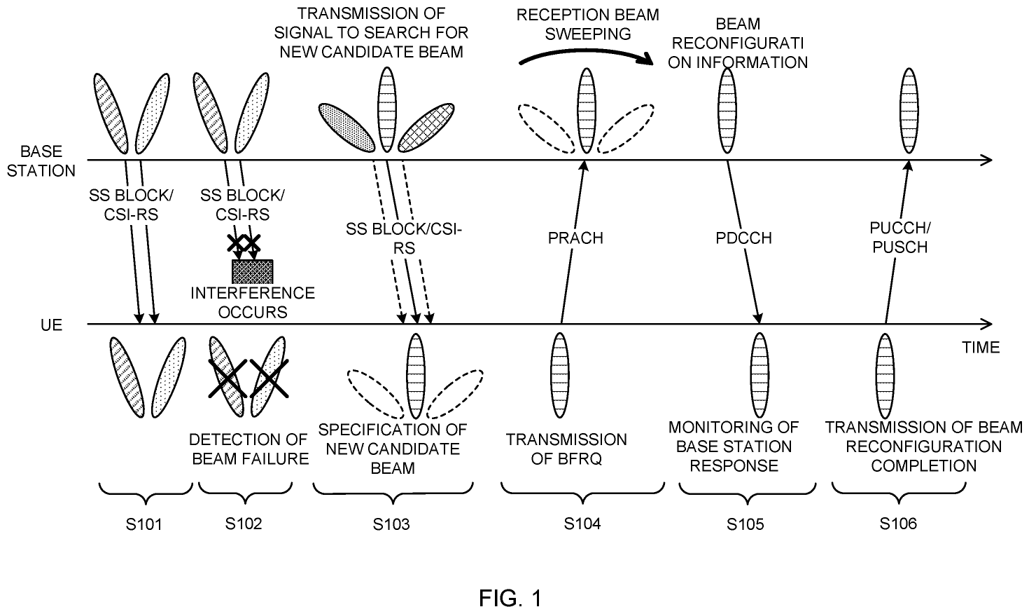

FIG. 1 is a diagram illustrating an example of a beam recovery procedure in Rel. 15 NR. The number of beams, or the like, is an example, and is not limited thereto. In an initial state (step S101) in FIG. 1, the UE performs measurement based on a reference signal (RS) resource transmitted using two beams.

The RS may be at least one of a synchronization signal block (SSB) or a channel state information RS (CSI-RS). Note that the SSB may also be referred to as an SS/physical broadcast channel (PBCH) block, or the like.

The RS may be at least one of a primary synchronization signal (primary SS (PSS)), a secondary synchronization signal (secondary SS (SSS)), a mobility reference signal (mobility RS (MRS)), a signal included in an SSB, the SSB, a CSI-RS, a demodulation reference signal (DMRS), a beam-specific signal, or the like, or a signal configured by extending or changing these. The RS measured in step S101 may be referred to as an RS for beam failure detection (beam failure detection RS (BFD-RS)), an RS (BFR-RS) for use in the beam recovery procedure, or the like.

In step S102, interference in radio waves from the base station occurs, whereby the UE cannot detect the BED-RS (or reception quality of the RS is degraded). Such interference may occur due to, for example, an effect of an obstacle between the UE and the base station, fading, interference, or the like.

Once a predetermined/given condition is satisfied, the UE detects a beam failure. For example, the UE may detect occurrence of a beam failure when a block error rate (BLER) is less than a threshold value for all of configured BFD-RSS (BFD-RS resource configurations). When the occurrence of the beam failure is detected, a lower layer (physical (PHY) layer) of the UE may perform notification (indication) of a beam failure instance to a higher layer (MAC layer).

Note that a criterion for determination is not limited to the BLER, and may be reference signal received power in a physical layer (Layer 1 reference signal received power (L1-RSRP)). Further, instead of RS measurement or in addition to RS measurement, beam failure detection may be performed based on a downlink control channel (physical downlink control channel (PDCCH)) or the like. The BFD-RS may be expected to be in a quasi-co-location (QCL) with a DMRS of the PDCCH monitored by the UE.

Here, the QCL is an indicator indicating a statistical property of a channel. For example, a case where one signal/channel and another signal/channel have a QCL relation may mean that it is possible to assume that at least one of Doppler shift, Doppler spread, an average delay, a delay spread, and a spatial parameter (for example, a spatial Rx parameter) is identical (in QCL with at least one of these) between a plurality of these different signals/channels.

Note that the spatial Rx parameter may correspond to a reception beam of the UE (for example, a reception analog beam), and the beam may be specified based on spatial QCL. The QCL (or at least one element of the QCL) in the present disclosure may be replaced with spatial QCL (sQCL).

Information regarding the BFD-RS (for example, an RS index, resource, number, number of ports, precoding, or the like), information regarding beam failure detection (BFD) (for example, the above-described threshold value), or the like may be configured in (notified to) the UE by using higher layer signaling, or the like. The information regarding the BFD-RS may also be referred to as information regarding a resource for BFR, or the like.

In the present disclosure, higher layer signaling may be, for example, any of radio resource control (RRC) signaling, medium access control (MAC) signaling, broadcast information, and the like, or a combination thereof.

For example, a medium access control control element (MAC CE), a MAC protocol data unit (PDU), or the like may be used for the MAC signaling. The broadcast information may be, for example, a master information block (MIB), a system information block (SIB), remaining minimum system information (RMSI), other system information (OSI), or the like.

The higher layer (for example, the MAC layer) of the UE may start a predetermined timer (which may also be referred to as a beam failure detection timer) when receiving a beam failure instance notification from the PHY layer of the UE. The MAC layer of the UE may trigger BFR (for example, start any one of random access procedures to be described later) after receiving the beam failure instance notification a certain number of times (for example, beamFailureInstanceMaxCount configured by RRC) or more before the timer expires.

The base station may determine that the UE has detected a beam failure when there is no notification from the UE or when a predetermined signal (beam recovery request in step S104) is received from the UE.

In step S103, the UE starts a search for a new candidate beam to be newly used for communication for beam recovery. The UE may measure a predetermined RS to select a new candidate beam corresponding to the RS. The RS measured in step S103 may be referred to as, for example, a new candidate RS, a new candidate beam identification RS (NCBI-RS), CBI-RS, and a candidate beam RS (CB-RS). The NCBI-RS may be the same as or different from the BFD-RS. Note that the new candidate beam may be simply referred to as a candidate beam, or a candidate RS.

The UE may determine a beam corresponding to an RS that satisfies a predetermined condition as a new candidate beam. The UE may determine a new candidate beam based on, for example, an RS whose L1-RSRP exceeds a threshold value among configured NCBI-RSs. Note that a criterion for determination is not limited to L1-RSRP. L1-RSRP regarding an SSB may also be referred to as SS-RSRP. L1-RSRP regarding a CSI-RS may also be referred to as CSI-RSRP.

Information regarding an NCBI-RS (for example, an RS resource, number, number of ports, precoding, or the like), information regarding new candidate beam identification (NCBI) (for example, the above-described threshold value), or the like may be configured in (notified) the UE using higher layer signaling, or the like. Information regarding the new candidate RS (or NCBI-RS) may be acquired based on the information regarding the BFD-RS. Information regarding the NCBI-RS may also be referred to as information regarding an NBCI resource or the like.

Note that the BFD-RS, NCBI-RS, or the like may be replaced with a radio link monitoring reference signal (RLM-RS).

In step S104, the UE that has specified the new candidate beam transmits a beam recovery request (beam failure recovery request (BFRQ)). The beam failure recovery request may also be referred to as a beam recovery request signal, a beam failure recovery request signal, or the like.

The BFRQ may be transmitted using, for example, at least one of a physical uplink control channel (PUCCH), a physical random access channel (PRACH), a physical uplink shared channel (PUSCH), or a configured grant (CG) PUSCH.

The BFRQ may include information regarding the new candidate beam or new candidate RS specified in step S103. The resource for the BFRQ may be associated with the new candidate beam. Beam information may be notified by using, for example, a beam index (BI), a port index of a predetermined reference signal, an RS index, a resource index (for example, CSI-RS resource indicator (CRI), SSB resource indicator (SSBRI)), or the like.

In Rel. 15 NR, contention-based BFR (CB-BFR) that is BFR based on a contention-based random access (RA) procedure and contention-free BFR (CF-BFR) that is BFR based on a non-contention based random access procedure have been studied. In the CB-BFR or the CF-BFR, the UE may transmit a preamble (which is also referred to as an RA preamble, a physical random access channel (PRACH), an RACH preamble, or the like) as the BFRQ by using a PRACH resource.

In the CB-BFR, the UE may transmit a preamble randomly selected from one or more preambles. Meanwhile, in the CF-BFR, the UE may transmit a preamble uniquely allocated to the UE from the base station. In the CB-BFR, the base station may allocate an identical preamble to a plurality of UEs. In the CF-BFR, the base station may allocate preambles individually to the UEs.

Note that the CB-BFR and the CF-BFR may also be referred to as CB PRACH-based BFR (contention-based PRACH-based BFR (CBRA-BFR)) and CF PRACH-free BFR (contention-free PRACH-based BFR (CFRA-BFR)), respectively. The CBRA-BFR may also be referred to as CBRA for BFR. The CFRA-BFR may also be referred to as CFRA for BFR.

In either the CB-BFR or the CF-BFR, the information regarding the PRACH resource (RA preamble) may be notified by, for example, higher layer signaling (RRC signaling and the like). For example, the information may include information indicating a correspondence relationship between the detected DL-RS (beam) and the PRACH resource, and different PRACH resources may be associated with each DL-RS.

In step S105, the base station that has detected the BFRQ transmits a response signal (which may also be referred to as a gNB response or the like) for the BFRQ from the UE. The response signal may include reconfiguration information (for example, DL-RS resource configuration information) for one or more beams.

The response signal may be transmitted in, for example, a UE common search space of PDCCH. The response signal may be notified by using PDCCH (DCI) scrambled in cyclic redundancy check (CRC) by an identifier of the UE (for example, cell-radio RNTI (C-RNTI)). The UE may determine at least one of a transmission beam or a reception beam to be used, based on beam reconfiguration information.

The UE may monitor the response signal based on at least one of a control resource set (CORESET) for BFR or a search space set for BFR.

For the CB-BFR, contention resolution may be determined to be successful in a case where the UE receives a PDCCH corresponding to the C-RNTI regarding the UE itself.

Regarding the processing of step S105, a period for the UE to monitor a response from the base station (for example, gNB) to the BFRQ may be configured. The period may be referred to as, for example, a gNB response window, a gNB window, a beam recovery request response window, or the like. The UE may retransmit the BFRQ in a case where no gNB response is detected within the window period. In step S106, the UE may transmit a message indicating that beam reconfiguration is completed to the base station. The message may be transmitted by the PUCCH or PUSCH, for example.

Beam recovery success (BR success) may represent a case where the processing reaches step S106, for example. On the other hand, beam recovery failure (BR failure) may correspond to, for example, a case where the number of times of BFRQ transmission has reached a predetermined number, or a beam-failure-recovery-timer has expired.

Rel. 15 supports performing the beam recovery procedure (for example, notification of BFRQ) for a beam failure detected by an SpCell (PCell/PSCell) using a random access procedure. On the other hand, Rel. 16 and subsequent releases supports performing the beam recovery procedure (for example, notification of BFRQ) for the beam failure detected by the SCell using at least one of PUCCH (for example, a scheduling request (SR)) transmission for BFR or MAC CE (for example, UL-SCH) transmission for BFR.

For example, the UE may use MAC CE-based two steps to transmit information regarding the beam failure. The information regarding the beam failure may include information regarding a cell in which the beam failure is detected, and information regarding a new candidate beam (or a new candidate RS index).

### [Step 1]

When a BF is detected, a PUCCH-BFR (scheduling request (SR)) may be transmitted from the UE to the PCell/PSCell. Then, a UL grant (DCI) for the following Step 2 may be transmitted from the PCell/PSCell to the UE. When a beam failure is detected and there is a MAC CE (or UL-SCH) for transmitting information regarding the new candidate beam, Step 1 (for example, PUCCH transmission) may be omitted and Step 2 (for example, MAC CE transmission) may be performed.

### [Step 2]

Then, the UE may transmit information (for example, a cell index) regarding the cell in which the beam failure is detected (failed) and information regarding the new candidate beam to the base station (PCell/PSCell) through an uplink channel (for example, the PUSCH) using the MAC CE. Thereafter, after a predetermined period (for example, 28 symbols) from reception of the response signal from the base station through the BFR procedure, the QCL of PDCCH/PUCCH/PDSCH/PUSCH may be updated to a new beam.

Note that numbers of these steps are merely numbers for description, and a plurality of these steps may be combined, or the order of these steps may be changed. Further, whether or not to perform BFR may be configured in the UE by using higher layer signaling.

Meanwhile, in a future radio communication system (for example, Rel. 17 and subsequent releases), beam management of a UE having a plurality of panels (multi-panels) or extension of beam management using a plurality of transmission/reception points (multi-transmission/reception points (TRP)) has been studied.

When a terminal (UE) performs communication by using a plurality of transmission/reception points (TRP)/UE panels, it is conceivable that beam failure detection in a TRP/UE panel unit (or each TRP/UE panel) is supported. However, there are insufficient considerations as to how to control the beam failure detection (BFD) or beam failure recovery (BFR) procedure in a TRP/UE panel unit.

In the existing system (for example, Rel. 16 NR), in the SCell, when the quality of all BFD-RSs (or BFR-RSs) configured in the UE is equal to or less than a certain threshold value, the BFR is performed using the MAC CE. On the other hand, in a case where beam failure detection in TRP units is supported, when the quality of BFD-RS (for example, all BFD-RSs) corresponding to a certain TRP among the BFD-RSs configured in the UE is equal to or less than a certain threshold, it is conceivable that the BFR is performed using the MAC CE.

In NR Rel. 16, it is supported that the UE determines a certain beam having the best quality (for example, maximum L1-RSRP) for each configured new candidate beam (or new candidate RS).

The BFR MAC CE before Rel. 16 may include at least one of a bit field indicating a cell in which a BF is detected, a reserved bit field, a candidate RS ID or reserved bit field (which may be simply referred to as a candidate RS ID field), a BFD indication field for an SpCell, or a field indicating the presence of a candidate RS ID. The reserved bit field does not have to be particularly used for notification of information, or may be freely used. The reserved bit field may be fixed to a given value (for example, 0) in the specification.

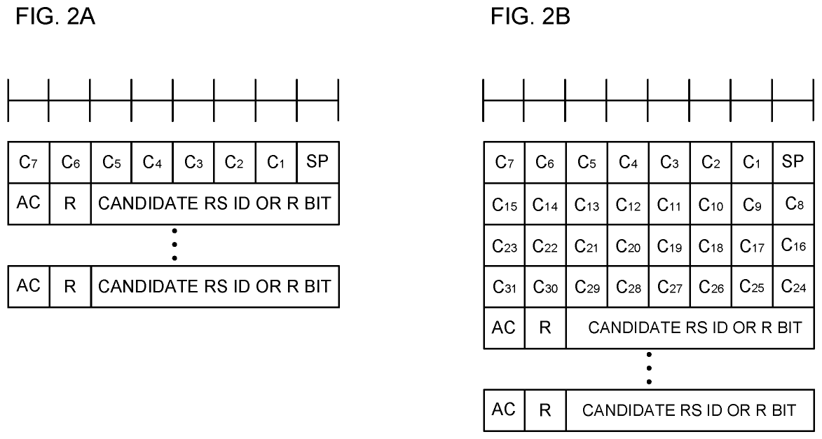

FIGS. 2A and 2B are diagrams illustrating a configuration of the BFR MAC CE before Rel. 16. FIG. 2A illustrates an example of the MAC CE configuration in a case where a field indicating a cell in which a BF is detected for eight or less cells (or seven or less SCells) is included. FIG. 2B illustrates an example of the MAC CE configuration in a case where a field indicating a cell in which a BF is detected for 32 or less cells is included.

In FIGS. 2A and 2B, a Cₙ bit (n is an integer of 1 or more) is a bit field indicating a cell in which a BF is detected, an SP bit is a BFD indication field for the SpCell, an AC bit is the field indicating the presence of a candidate RS ID, and an R bit is a reserved bit. Hereinafter, in the present disclosure, the Cₙ bit and the R bit in the diagram illustrating the MAC CE configuration are similar.

On the other hand, in Rel. 17 and subsequent releases, as described above, it is assumed that the detection of the beam failure (notification of the cell in which BFD is detected)/notification of the candidate RS is controlled for each TRP (or in TRP units).

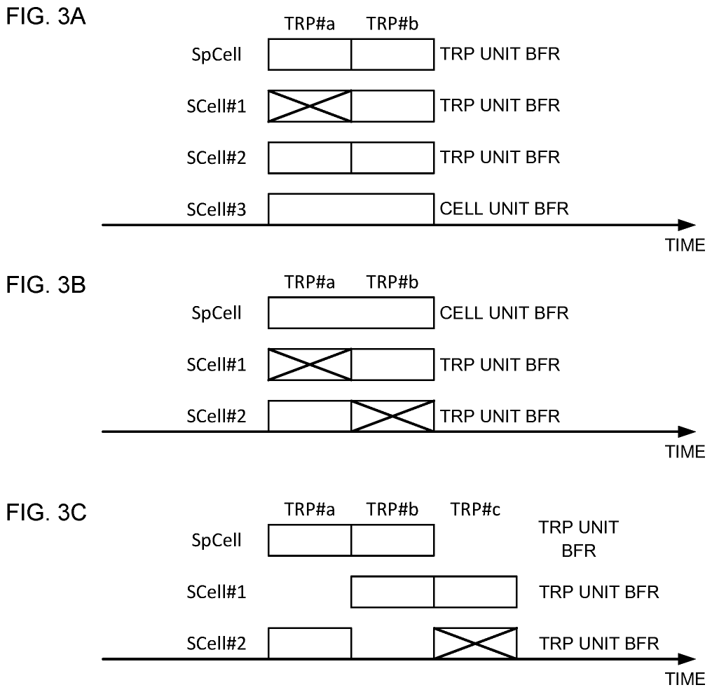

FIGS. 3A to 3C illustrate an example of a case where a BFR in cell units/TRP units is configured for each of a plurality of serving cells configured in the UE.

FIG. 3A illustrates a case where a certain cell group includes an SpCell and SCell #1 to SCell #3, the BFR in TRP units is configured for an SpCell and SCell #1 and SCell #2, and the BFR in cell units is configured for the SCell #3. Here, a case where the beam failure of the TRP #a of the SCell #1 is detected is illustrated.

FIG. 3B illustrates a case where a certain cell group includes the SpCell and the SCell #1 and the SCell #2, the BFR in cell units is configured for the SpCell, and the BFR in TRP units is configured for the SCell #1 and the SCell #2. Here, a case where the UE detects the beam failure of the TRP #a of the SCell #1 and the TRP #b of the SCell #2 is illustrated.

FIG. 3C illustrates a case where a certain cell group includes the SpCell and the SCell #1 and the SCell #2, and the BFR in TRP units is configured for the SpCell and the SCell #1 and the SCell #2. Further, a case where the TRP #a and the TRP #b are configured for the SpCell, the TRP #b and the TRP #c are configured for the SCell #1, and the TRP #a and the TRP #c are configured for the SCell #2 is illustrated. In addition, here, a case where the beam failure of the TRP #c of the SCell #2 is detected is illustrated.

As described above, in a case where it is supported that the BFR configuration/beam failure detection unit is separately configured for each cell, how to report the beam failure detection in TRP units or the like becomes a problem. If the beam failure recovery procedure (or the radio link recovery procedure) in each TRP/UE panel cannot be appropriately controlled, communication throughput may decrease or communication quality may deteriorate.

The present inventors have focused on the possibility that a beam failure recovery procedure (beam failure detection/beam failure recovery request/UE operation based on beam failure recovery) is applied in one or more TRP/panel units, studied a method of appropriately controlling the beam failure recovery procedure in TRP units/panel units, and conceived the present embodiment.

Hereinafter, embodiments according to the present disclosure will be described in detail with reference to the drawings. The respective aspects may be applied individually or in combination.

In the present disclosure, the UE may be a UE that performs transmission and reception with a TRP using a plurality of panels. Each panel may correspond to a different TRP, one panel may correspond to a plurality of TRPs, or a plurality of panels may correspond to one TRP.

In the present disclosure, a UE panel (or panel index) may correspond to a specific group. In this case, the UE may assume that a beam/RS of each group is measured in each UE panel. The UE may assume that beams of a plurality of groups are simultaneously received (using different panels).

In the present disclosure, the TRP may be replaced with a panel of a TRP (or a base station), an RS group, an antenna port group, a spatial relation group, a QCL group, a TCI state, a TCI state group, a CORESET group, a CORESET pool, or the like. Further, a TRP index may be replaced with an RS group index, an antenna port group index, a QCL group index, a TCI state index, a TCI state group index, a CORESET group index, a CORESET pool index, or the like.

In the present disclosure, in a case where a single DCI is applied, an n-th TRP (n is an arbitrary integer (for example, 1 or 2)) may correspond to an n-th TCI state and an n-th code division multiplexing (CDM) group.

In the present disclosure, in a case where multiple pieces of DCI are applied, a first TRP may correspond to a CORESET without CORESETPoolIndex or a CORESET with CORESETPoolIndex=0. A second TRP may correspond to a CORESET with CORESETPoolIndex=1.

In the present disclosure, the UE panel may be replaced with an RS group, an antenna port group, a spatial relation group, a QCL group, a TCI state group, a CORESET group, or the like.

In the present disclosure, a panel may be associated with a group index of an SSB/CSI-RS group. Further, in the present disclosure, a panel may be associated with a TRP. In addition, in the present disclosure, a plurality of panels may be associated with a group index of group beam-based reporting. Further, in the present disclosure, a panel may be associated with a group index of an SSB/CSI-RS group for group beam-based reporting.

In the present disclosure, the serving cell/cell may be replaced with a PCell, a PSCell, or an SCell. In the following description, a case where two TRPs correspond to the serving cell will be described as an example, but three or more TRPs may correspond to the serving cell.

In the present disclosure, a BFD RS for which a beam failure is detected, a failed BFD RS, a TRP for which a beam failure is detected, a failed TRP, a UE panel for which a beam failure is detected, and a failed UE panel may be replaced with each other.

In the present disclosure, A/B may indicate at least one of A or B. In the present disclosure, A/B/may indicate at least one of A, B, or C.

### First Embodiment

In the first embodiment, a UE operation (for example, report using MAC CE) in a case where a BFR procedure (for example, BFR detection/BFR report) in TRP units is supported/configured will be described.

In the following description, a case where two TRPs are considered as a case where the BFR procedure in TRP units is configured in a cell will be described, but the number of TRPs is not limited thereto. In the following description, the MAC CE may be replaced with a BFR MAC CE or an extended BFR MAC CE. In the following description, a cell may be replaced with a serving cell, SpCell (for example, PCel/SpCell), or a secondary cell (for example, SCell).

The network (for example, a base station) may notify/configure information regarding a BFR configuration/beam failure detection unit in each cell to the UE by using higher layer signaling. The BFR configuration/beam failure detection unit may indicate whether detection of a beam failure is performed in cell units or TRP units. The BFR configuration/beam failure detection unit may be referred to as a beam failure detection type.

The BFR in cell units may be replaced with a BFR per cell (for example, per-cell BFR) or a BFR specific to a cell (for example, cell-specific BFR). The BFR in TRP units may be read as a BFR per TRP (for example, per-TRP BFR) or BFR per multi-TRPs (multi-TRP BFR).

For example, it is assumed that the beam failure detection unit is configured as “cell unit” for a first cell and “TRP unit” for a second cell. In such a case, the UE may control to perform beam failure detection/reporting in cell units in the first cell and perform beam failure detection/reporting in TRP units in the second cell. Note that the UE may perform the BFR procedure in “TRP units” for a cell in which a predetermined higher layer parameter is configured, and may perform the BFR procedure in “cell units” for a cell in which a predetermined higher layer parameter is not configured.

When the beam failure detection unit is configured as the “TRP unit” for a certain cell, information regarding the TRP configured for the cell may be notified/configured in the UE. The information related to the TRP may be, for example, information regarding a reference signal or the like corresponding to each TRP index, or may be information regarding a reference signal or the like corresponding to each of the first TRP and the second TRP.

When a beam failure is detected in a certain cell/TRP (or when the BFR is triggered), the UE may send information regarding the beam failure to a base station (for example, PCell/PSCell) by using a MAC CE (or UL-SCH/PUSCH). The information regarding the beam failure may be at least one of information regarding a cell in which the beam failure is detected, information regarding a new beam (for example, a new candidate RS index), and information regarding a failed TRP/cell.

The information regarding the TRPs on which the beam failure is detected (for example, the first TRP/the second TRP) may be information regarding the panels on which the beam failure is detected.

The MAC CE used in the BFR procedure may include a predetermined field used for notification of the TRP in which the beam failure is detected. The predetermined field may be referred to as a TRP notification field (for example, the TRP-ID indication field), a BFR notification field in TRP units, a cell/TRP notification field, or a BFR notification field in cell/TRP units.

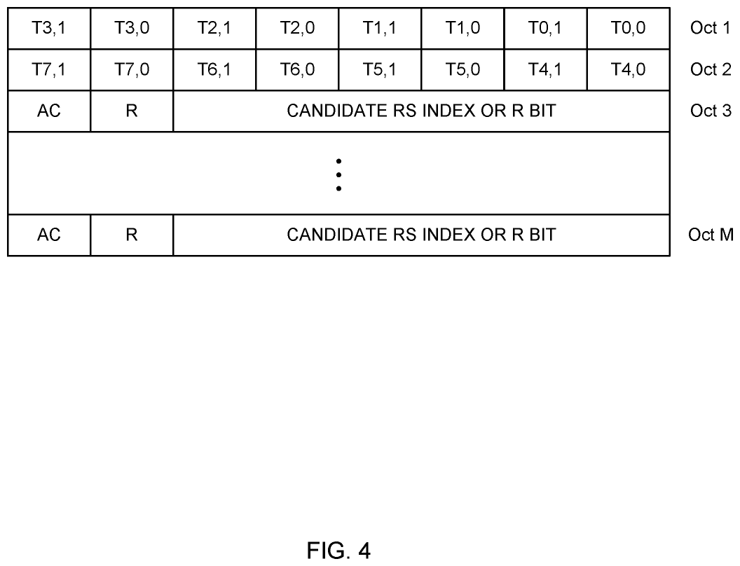

FIG. 4 illustrates an example of a BFR MAC CE configuration including a TRP notification field (or a cell/TRP advertisement field). The MAC CE in FIG. 4 includes at least a TRP notification field and a new candidate beam notification field.

Each TRP notification field may correspond to a specific cell index. For example, the cell i (Ci) may correspond to Ti, 1 and Ti, 0 in the TRP notification field. That is, Ti, 1 and Ti, 0 may indicate the state of the beam failure corresponding to the cell i.

In FIG. 4, cell 0 corresponds to T0,0 and T0,1, cell 1 corresponds to T1, 0 and T1, 1, and . . . cell 7 corresponds to T7,0 and T7,1. Cell 0 (for example, C0/SP) may correspond to the SpCell, and cell 1 to cell 7 may correspond to the secondary cell.

Here, a case where two bits (for example, one bit of Ti, 0 and one bit of Ti, 1) are used for notification of a TRP index corresponding to a certain cell (for example, cell i) has been described, but the notification of the TRP index is not limited thereto. Ti, 0 and Ti, 1 are separated for the cell i, but Ti, 0 and Ti, 1 may be provided without being distinguished (for example, in two bits).

The predetermined field (hereinafter, also referred to as a TRP notification field) may indicate a beam failure in cell units or a transmission/reception point at which the beam failure is detected based on a BFR configuration/beam failure detection unit (for example, “cell unit”/“TRP unit”) of a corresponding cell. The meaning/interpretation indicated by a predetermined bit value (or a code point) of the TRP notification field may be different based on the beam failure detection unit of the corresponding cell. The predetermined bit value may be a part of a plurality of bit values (or a code point). The predetermined bit value may be, for example, 11.

When (Ti, 1 and Ti, 0)=00, it may indicate that a beam failure in the cell i is not detected.

When (Ti, 1 and Ti, 0)=01, it may indicate that a beam failure in the first TRP/first BFD-RS set (for example, TRP #0/BFD-RS set #0) of the cell i is detected. In this case, it may be expected that there is one octet (Oct) for one candidate RS-ID and AC field for the cell i. The candidate RS-ID may correspond to an RS included in a first new candidate beam RS set (for example, NBI-RS set #0). The first new candidate beam RS set may be a new candidate beam RS set associated with the BFD-RS set #0.

The AC field may indicate the presence of a candidate RS-ID field in an octet including the AC field. When AC=1, it indicates that a new candidate beam has been found or a candidate RS-ID exists (for example, there is an RS of predetermined RSRP or more), and otherwise, AC=0 may be configured. When the AC field is configured as 0, there may instead be a reserved bit (for example, R bits).

In the cell in which the BFR in cell units is configured, (Ti, 1 and Ti, 0)=01 may not be selected/used.

When (Ti, 1 and Ti, 0)=10, it may indicate that a beam failure in the second TRP/second BFD-RS set (for example, TRP #1/BFD-RS set #1) of cell i is detected. In this case, for cell i, the 1-octet Ti, 1 and Ti, 0 beam RS set for one candidate RS-ID and AC field may be a new candidate beam RS set associated with BFD-RS set #1. In the cell in which the BFR in cell units is configured, (Ti, 1 and Ti, 0)=10 may not be selected/used.

When (Ti, 1 and Ti, 0)=11, the meaning/interpretation indicated by the bit value (or a code point)=11 may be different based on the BFR configuration/beam failure detection unit (for example, “cell unit”/“TRP unit”) of the cell i.

For example, when (Ti, 1 and Ti, 0)=11, it may indicate whether it is a failure in each cell i (for example, per-cell failure) or a failure of two TRPs of the cell i (for example, two TRPs failure) based on the beam failure detection unit of the cell i.

In a case where the BFR in cell units (for example, a BFR specific to a cell (cell-specific BFR)) is configured for the cell i, the bit value (or a code point)=11 means a beam failure of a cell, and it may be expected that there is one octet for one candidate RS-ID and one AC field for the CC (for example, cell i).

In a case where the BFR in TRP units (for example, a multi-TRP BFR (multi-TRP BFR)) is configured for the cell i, the bit value (or a code point)=11 means a beam failure of two TRPs, and it may be expected that there are two octets (first octet and second octet) for two candidate RS-IDs and two AC fields for the CC (for example, cell i).

For example, the first octet may correspond to an RS included in the first new candidate beam RS set (for example, NBI-RS set #0). The first new candidate beam RS set may be a new candidate beam RS set associated with the BFD-RS set #0. The second octet may correspond to an RS included in a second new candidate beam RS set (for example, NBI-RS set #1). The second new candidate beam RS set may be a new candidate beam RS set associated with the BFD-RS set #1.

Note that, here, the case where the BFR configuration/beam failure detection unit is configured for each cell (for example, CC) has been described, but the BFR configuration/beam failure detection unit is not limited thereto. In the present disclosure, the BFR configuration/beam failure detection unit may be configured for each bandwidth part (for example, the BWP). In this case, the present disclosure may be applied by replacing the cell with the BWP.

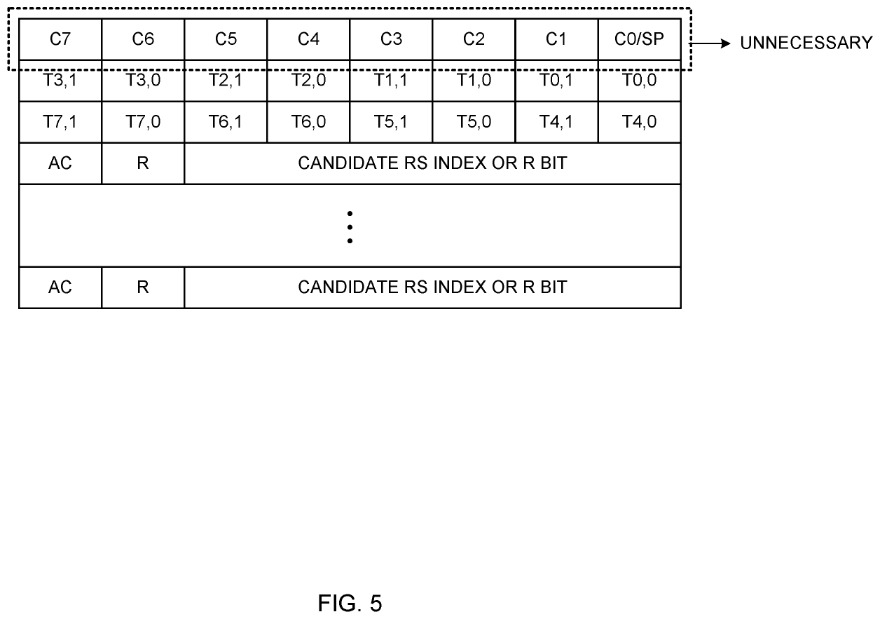

As described above, in the configuration of the MAC CE illustrated in FIG. 4, a field (for example, serving cell field) in a bitmap format explicitly indicating the serving cell can be made unnecessary. Thus, as compared with the configuration of the MAC CE (for example, FIG. 5) including the field explicitly indicating the serving cell, the cell fields (C0 to C7 fields in FIG. 5) corresponding to respective cells can be made unnecessary, so that an overhead of the MAC CE can be reduced.

Note that the correspondence relationship between each cell (for example, a cell configured or activated by the RRC/MAC CE) and the predetermined field (for example, the TRP notification field) may be determined on the basis of a predetermined rule. For example, they may be associated with the TRP notification field (Ti, 1 and Ti, 0) in ascending order of configured or activated cell indexes. Alternatively, the correspondence relationship between the cell and the TRP notification field may be notified/configured in the UE in RRC.

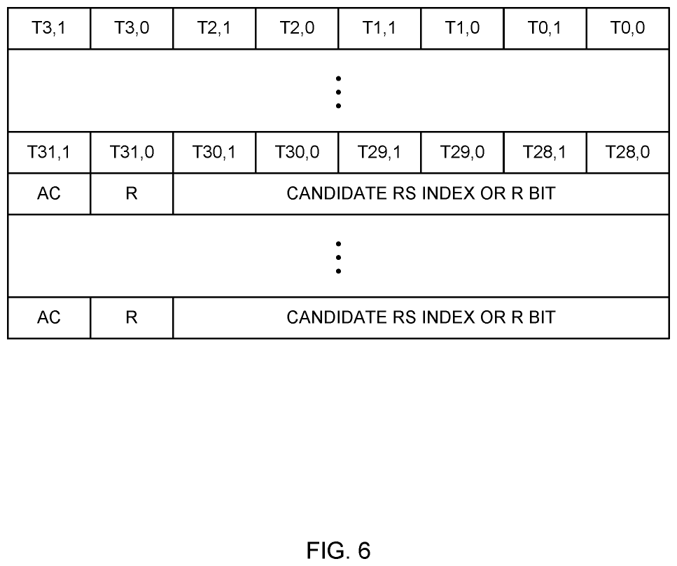

In FIG. 4, it may be applied when the number of SCells for which the BFR is configured is less than eight, that is, when the maximum serving cell index of the SCell of the MAC entity for which the beam failure detection is configured is less than eight. In a case where the number of SCells for which the BFR is configured is eight or more, the MAC CE configuration illustrated in FIG. 6 may be applied. The MAC CE illustrated in FIG. 6 illustrates a case where eight or more SCells and one or more TRP fields corresponding to each SCell are included.

A UE supporting both the BFR MAC CE before Rel. 16 and the BFR MAC CE in Rel. 17 and subsequent releases may determine, based on the BFR configuration/beam failure detection unit configured in a cell in which a beam failure is detected, a MAC CE to be used for reporting information regarding beam failure detection.

For example, when the cell (or CC) in which the beam failure occurs is only the CC configured in a cell unit BFR, the UE may apply the first BFR MAC CE (for example, the BFR MAC CE supported before Rel. 16) that does not include the TRP notification field. On the other hand, when at least one cell among the cells in which the beam failure occurs is a cell configured in TRP units (or the multi-TRP BFR), the UE may apply the second BFR MAC CE (for example, the BFR MAC CE in Rel. 17 and subsequent releases) in which the TRP notification field is supported.

In a case where the second BFR MAC CE (for example, the BFR MAC CE in Rel. 17 and subsequent releases) is applied, it means that a BFR failure occurs in at least one TRP. Thus, the UE may assume/determine that at least one pair (Ti, 1 and Ti, 0)=10, 01, or 11 exists in the cell in which the BFR in TRP units (or the multi-TRP BFR) is configured.

### Second Embodiment

In a second embodiment, a UE operation (for example, report using MAC CE) based on the BFR configuration/beam failure detection unit of a specific cell (for example, SpCell) will be described. The second embodiment may be applied in combination with the first embodiment.

Different interpretation/operation from other cells (for example, the SCell) may be applied to the cell/TRP notification field (for example, T0,1 and T0,0) corresponding to a specific cell (for example, SpCell).

In a case where the BFR in cell units (for example, per-cell BFR) is configured for the SpCell, there may be no octet (for example, in the BFR MAC CE described in the first embodiment) for the candidate RS-ID. The candidate RS-ID corresponding to the SpCell may be transmitted using a random access procedure (for example, message 3/message A).

When the BFR in TRP units (for example, per-TRP BFR) is configured for the SpCell, there may be at most one octet for the candidate RS-ID for only one TRP beam failure. In this case, the information (for example, the MAC CE) regarding the candidate RS-ID may be transmitted not on the PUSCH of the random access procedure (for example, message 3/message A) but on other PUSCH (for example, normal PUSCH). On the other hand, the report when the beam failure of the two TRPs occurs may be performed using a random access procedure (for example, message 3/message A).

This means that, for the SpCell, there is no case of (T0,1 and T0,0)=11, or if the information regarding the candidate RS-ID (for example, the MAC CE) is transmitted on the normal PUSCH instead of the PUSCH of message 3/message A, two octets for the candidate RS-IDs for the two TRPs of SpCell are not present.

When the SpCell in which the BFR in TRP units (for example, per-TRP BFR) is applied/configured is configured, and a beam failure occurs at the two TRPs to trigger the RACH, the BFR MAC CE may be transmitted in message 3/message A to indicate the purpose of the RACH. At least one of the following options 2-1 to 2-3 may be applied as the BFR MAC CE included in the random access procedure (for example, message 3/message A).

### <<Option 2-1>>

The BFR MAC CE transmitted in the random access procedure (for example, message 3/message A) may be the first BFR MAC CE that does not include the TRP notification field. For the first BFR MAC CE, the BFR MAC CE in Rel. 16 may be reused.

An indication of a predetermined bit (for example, one bit) for SpCell may be included in the BFR MAC CE in Rel. 16 to indicate a beam failure of the SpCell. The UE may notify the information regarding the beam failure of the SpCell (for example, presence or absence of beam failure/candidate RS index) using a predetermined bit.

When a synchronization signal block (SSB) associated with a RACH corresponds to a candidate beam for the SpCell, one bit may be sufficient as the number of bits used to indicate information regarding a beam failure of the SpCell (for example, presence or absence of beam failure/candidate RS index).

### <<Option 2-2>>

The BFR MAC CE transmitted in the random access procedure (for example, message 3/message A) may be the second BFR MAC CE including the TRP notification field. The second BFR MAC CE may be the BFR MAC CE supported in Rel. 17 and subsequent releases.

For example, the UE may use one bit (for example, 1) or two bits (for example, 01, 10, or 11) from (T0,1 and T0,0) to transmit information regarding the beam failure to indicate the beam failure of the SpCell. The information regarding the beam failure may be information indicating whether or not a beam failure has occurred or which TRP (first TRP/second TRP) has beam failure occurred.

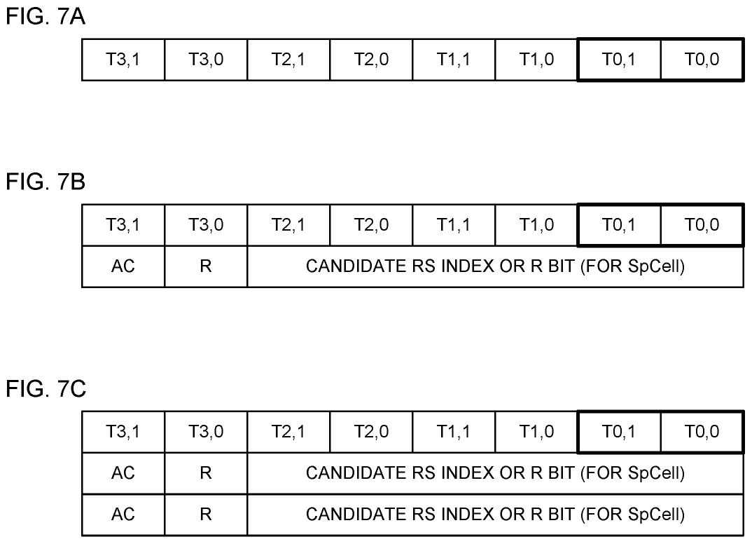

In this case, an octet (or the candidate RS-ID notification field) corresponding to the candidate RS-ID for the SpCell (TRP #0/TRP #1 of SpCell) may not be provided (see FIG. 7A). For example, one octet having the TRP notification field (T0,1 and T0,0) of the SpCell may be included in the MAC CE.

### <<Option 2-3>>

The BFR MAC CE transmitted in the random access procedure (for example, message 3/message A) may be the second BFR MAC CE including the TRP notification field. The second BFR MAC CE may be the BFR MAC CE supported in Rel. 17 and subsequent releases.

For example, the UE may use one bit (for example, 1) or two bits (for example, 01, 10, or 11) from (T0,1 and T0,0) to transmit information regarding the beam failure to indicate the beam failure of the SpCell. The information regarding the beam failure may be information indicating whether or not a beam failure has occurred or which TRP (first TRP/second TRP) has beam failure occurred.

Furthermore, one or two octets (or the candidate RS-ID notification field) corresponding to candidate RS-IDs for one or two TRPs of SpCell may be provided (see FIGS. 7B and 7C).

FIG. 7B illustrates a case where one octet (or the candidate RS-ID notification field/AC field) corresponding to the candidate RS-ID for one TRP (for example, TRP #0 or TRP #1) of SpCell is provided.

FIG. 7C illustrates a case where two octets (or the candidate RS-ID notification field/AC field) corresponding to candidate RS-IDs for two TRPs (for example, TRP #0 and TRP #1) of SpCell are provided.

[Option 2-3-1]

One octet for the candidate RS-ID for one TRP (or the BFR-RS/NBI-RS set ID) and a TRP corresponding to the octet may be indicated by a predetermined bit (for example, 01 or 10) of the TRP notification field (for example, T0,1 and T0,0).

Note that the SSB associated with the PRACH may correspond to a candidate beam corresponding to one TRP of SpCell. Therefore, candidate beams corresponding to other TRPs may be reported by the PRACH (for example, a case of 11). Alternatively, information regarding candidate beams corresponding to the same TRP may be respectively reported on the PRACH and the MAC CE.

[Option 2-3-2]

Two octets for the candidate RS-IDs for two TRPs (or the BFR-RS/NBI-RS set ID) may be indicated by a predetermined bit (for example, 11) of the TRP notification field (for example, T0,1 and T0,0).

### Variations

FIGS. 7A to 7C illustrate a case where the number of corresponding cells (or CC) is four (for example, cells #0 to #3), but the number of corresponding cells is not limited thereto, and predetermined fields (for example, the TRP notification field) corresponding to four or more cells may be configured. Alternatively, only a predetermined field (for example, the TRP notification field) corresponding to a specific cell (for example, SpCell) may be configured.

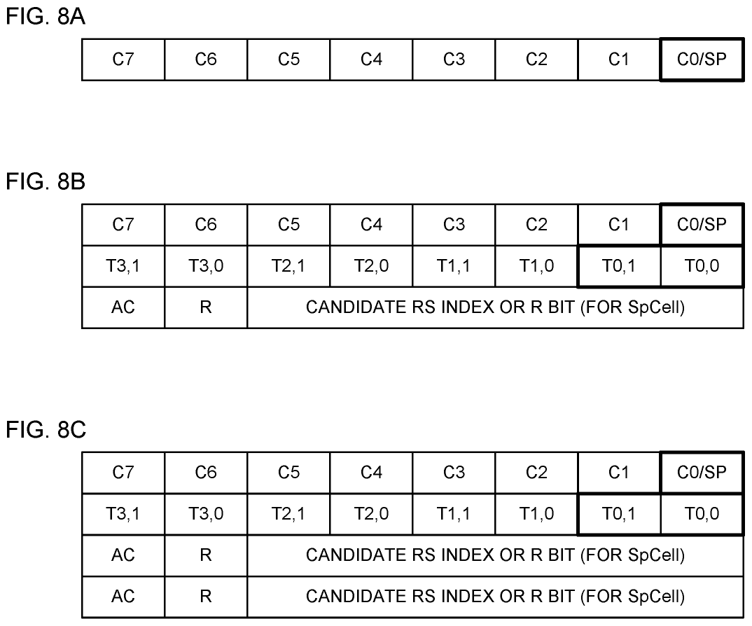

Furthermore, in the MAC CE in FIGS. 7A to 7C, a configuration in which the cell index notification field (for example, the C field) is not provided is illustrated, but a configuration in which the cell index notification field is provided may be employed (see FIGS. 8A to 8C). Note that, as compared with FIGS. 8A to 8C, an increase in the overhead of the MAC CE can be suppressed by using the MAC CE configuration in FIGS. 7A to 7C.

As described above, when the BFR in TRP units is applied/configured for a specific cell (for example, SpCell), a report using at least one of the PUSCH of the random access procedure and the PUSCH other than the random access procedure may be supported according to the number of TRPs in which the beam failure is detected. Thus, it is possible to flexibly control the reporting of the information regarding the BFR in a case where the BFR in TRP units is applied to the SpCell.

When the BFR in TRP units is applied/configured for a specific cell (for example, SpCell), the beam failure in TRP units can be appropriately performed by including the TRP notification field in the MAC CE transmitted on the PUSCH in the random access procedure.

### <UE Capability Information>

In the first and second embodiments, the following UE capabilities may be configured. Note that the UE capability described below may be replaced with a parameter (for example, higher layer parameter) configured from the network (for example, base station) to the UE.

UE capability information regarding whether or not to support transmission of a BFR MAC CE (for example, a MAC CE including a TRI notification field) in Rel. 17 and subsequent releases in a random access procedure (for example, message 3/message A) may be defined.

In beam failure detection, the UE capability information may be defined regarding whether or not to support multiple (for example, two) sets/groups of RSs.

In the detection of a new candidate beam (or a new candidate RS), the UE capability information may be defined regarding whether or not to support multiple (for example, two) sets/groups of RSs.

The UE capability information regarding whether or not to support notification of TRP index information for a predetermined operation may be defined in information exchange between a physical layer (for example, UE PHY) and a higher layer (for example, UE higher layer) in the UE. The predetermined operation may be at least one of a beam failure detection notification (beam failure indication), a request from a higher layer, and new candidate beam information.

The UE capability information may be defined regarding whether or not a two-step MAC CE-based BFR for a given cell is supported. The predetermined cell may be, for example, SpCell (for example, PCell/PSCell) for which multi-TRPs are configured.

The UE capability information may be defined regarding whether or not multiple (for example, two) predetermined counters (for example, BFI_COUNTER) are supported for the serving cell.

The UE capability information may be defined regarding whether or not multiple (for example, two) predetermined timers (for example, beamFailureDetectionTimer) are supported for the serving cell.

The UE capability information may be defined regarding whether or not multiple (for example, two) BFR triggers are supported for the serving cell.

The UE capability information may be defined regarding whether or not multiple (for example, two) SRs are supported for the serving cell.

The UE capability information may be defined regarding whether or not a configuration in which an SR is associated with a TRP is supported.

The UE capability information may be defined regarding whether an extended BFR MAC CE for a given cell is supported in a multi-TRP scenario. The predetermined cell may be SpCell (for example, PCell/PSCell)/SCell.

The first and second embodiments may be applied to a UE that supports/reports at least one of the UE capabilities described above. Alternatively, the first and second embodiments may be applied to a UE configured from a network.

Note that which of the control methods described in at least one of the first embodiment or the second embodiment is applied may be notified/configured in the UE by a higher layer parameter. Alternatively, the UE may report as capability information (for example, the UE capability).

### (Radio Communication System)

Hereinafter, a configuration of a radio communication system according to one embodiment of the present disclosure will be described. In this radio communication system, communication is performed using any one of the radio communication methods according to the embodiments of the present disclosure or a combination thereof.

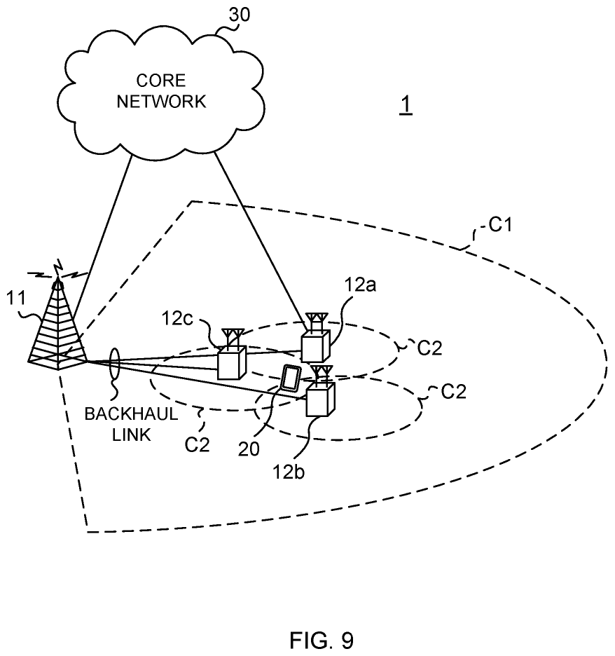

FIG. 9 is a diagram illustrating an example of a schematic configuration of the radio communication system according to one embodiment. A radio communication system 1 may be a system that implements communication using long term evolution (LTE), 5th generation mobile communication system New Radio (5G NR), and the like drafted as the specification by third generation partnership project (3GPP).

Further, the radio communication system 1 may support dual connectivity (multi-RAT dual connectivity (MR-DC)) between a plurality of radio access technologies (RATs). The MR-DC may include dual connectivity between LTE (evolved universal terrestrial radio access (E-UTRA)) and NR (E-UTRA-NR dual connectivity (EN-DC)), dual connectivity between NR and LTE (NR-E-UTRA dual connectivity (NE-DC)), and the like.

In the EN-DC, an LTE (E-UTRA) base station (eNB) is a master node (MN), and an NR base station (gNB) is a secondary node (SN). In the NE-DC, an NR base station (gNB) is MN, and an LTE (E-UTRA) base station (eNB) is SN. The radio communication system 1 may support dual connectivity between a plurality of base stations in the same RAT (for example, dual connectivity in which both MN and SN are NR base stations (gNB) (NR-NR dual connectivity (NN-DC)).

The radio communication system 1 may include a base station 11 that forms a macro cell C1 with a relatively wide coverage, and base stations 12 (12a to 12c) that are disposed within the macro cell C1 and that form small cells C2 narrower than the macro cell C1. A user terminal 20 may be positioned in at least one cell. The arrangement, number, and the like of cells and the user terminals 20 are not limited to the aspects illustrated in the drawings. Hereinafter, the base stations 11 and 12 will be collectively referred to as “base stations 10” when the base stations 11 and 12 are not distinguished from each other.

The user terminal 20 may be connected to at least one of the plurality of base stations 10. The user terminal 20 may use at least one of carrier aggregation (CA) using a plurality of component carriers (CC) and dual connectivity (DC).

Each CC may be included in at least one of a first frequency band (frequency range 1 (FR1)) or a second frequency band (frequency range 2 (FR2)). The macro cell C1 may be included in FR1, and the small cell C2 may be included in FR2. For example, FR1 may be a frequency band of 6 GHz or less (sub-6 GHz), and FR2 may be a frequency band higher than 24 GHZ (above-24 GHZ). Note that the frequency bands, definitions, and the like of the FR1 and FR2 are not limited thereto, and, for example, the FR1 may correspond to a frequency band higher than the FR2.

Further, the user terminal 20 may perform communication in each CC using at least one of time division duplex (TDD) and frequency division duplex (FDD).

The plurality of base stations 10 may be connected to each other in a wired manner (for example, an optical fiber, an X2 interface, or the like in compliance with common public radio interface (CPRI)) or in a radio manner (for example, NR communication). For example, when NR communication is used as a backhaul between the base stations 11 and 12, the base station 11 corresponding to a higher-level station may be referred to as an integrated access backhaul (IAB) donor, and the base station 12 corresponding to a relay station (relay) may be referred to as an IAB node.

The base station 10 may be connected to a core network 30 via another base station 10 or directly. The core network 30 may include, for example, at least one of an evolved packet core (EPC), a 5G core network (5GCN), a next generation core (NGC), and the like.

The user terminal 20 may a terminal that corresponds to at least one of communication methods such as LTE, LTE-A, and 5G.

In the radio communication system 1, a radio access method based on orthogonal frequency division multiplexing (OFDM) may be used. For example, in at least one of downlink (DL) or uplink (UL), cyclic prefix OFDM (CP-OFDM), discrete Fourier transform spread OFDM (DFT-s-OFDM), orthogonal frequency division multiple access (OFDMA), single carrier frequency division multiple access (SC-FDMA), and the like may be used.

The radio access method may be referred to as a waveform. Note that in the radio communication system 1, another radio access method (for example, another single carrier transmission method or another multi-carrier transmission method) may be used as the UL and DL radio access method.

In the radio communication system 1, as a downlink channel, a physical downlink shared channel (PDSCH), a physical broadcast channel (PBCH), a physical downlink control channel (PDCCH), or the like shared by the user terminals 20 may be used.

Further, in the radio communication system 1, as an uplink channel, a physical uplink shared channel (PUSCH), a physical uplink control channel (PUCCH), a physical random access channel (PRACH), or the like shared by the user terminals 20 may be used.

User data, higher layer control information, a system information block (SIB), and the like are transmitted on the PDSCH. The PUSCH may transmit the user data, higher layer control information, and the like. Furthermore, a master information block (MIB) may be transmitted on the PBCH.

Lower layer control information may be transmitted on the PDCCH. The lower layer control information may include, for example, downlink control information (DCI) including scheduling information of at least one of the PDSCH and the PUSCH.

Note that the DCI that schedules the PDSCH may be referred to as DL assignment, DL DCI, or the like, and the DCI that schedules PUSCH may be referred to as UL grant, UL DCI, or the like. Note that the PDSCH may be replaced with DL data, and the PUSCH may be replaced with UL data.

For detection of the PDCCH, a control resource set (CORESET) and a search space may be used. The CORESET corresponds to a resource that searches for DCI. The search space corresponds to a search area and a search method for PDCCH candidates. One CORESET may be associated with one or more search spaces. UE may monitor CORESET associated with a certain search space based on search space configuration.

One search space may correspond to a PDCCH candidate corresponding to one or more aggregation levels. One or more search spaces may be referred to as a search space set. Note that “search space”, “search space set”, “search space configuration”, “search space set configuration”, “CORESET”, “CORESET configuration”, and the like in the present disclosure may be replaced with each other.

Uplink control information (UCI) including at least one of channel state information (CSI), delivery confirmation information (which may be referred to as, for example, hybrid automatic repeat request acknowledgement (HARQ-ACK), ACK/NACK, or the like), scheduling request (SR), and the like may be transmitted by the PUCCH. A random access preamble for establishing connection with a cell may be transmitted on the PRACH.

Note that in the present disclosure, downlink, uplink, and the like may be expressed without “link”. Further, various channels may be expressed without adding “physical” at the beginning thereof.

In the radio communication system 1, a synchronization signal (SS), a downlink reference signal (DL-RS), and the like may be transmitted. In the radio communication system 1, a cell-specific reference signal (CRS), a channel state information reference signal (CSI-RS), a demodulation reference signal (DMRS), a positioning reference signal (PRS), a phase tracking reference signal (PTRS), or the like may be transmitted as the DL-RS.

The synchronization signal may be, for example, at least one of a primary synchronization signal (PSS) or a secondary synchronization signal (SSS). A signal block including the SS (PSS or SSS) and the PBCH (and the DMRS for the PBCH) may be referred to as an SS/PBCH block, an SS block (SSB), or the like. Note that, the SS, the SSB, or the like may also be referred to as a reference signal.

Furthermore, in the radio communication system 1, a measurement reference signal (sounding reference signal (SRS)), a demodulation reference signal (DMRS), or the like may be transmitted as an uplink reference signal (UL-RS). Note that, DMRSs may be referred to as “user terminal-specific reference signals (UE-specific Reference Signals)”.

### (Base Station)

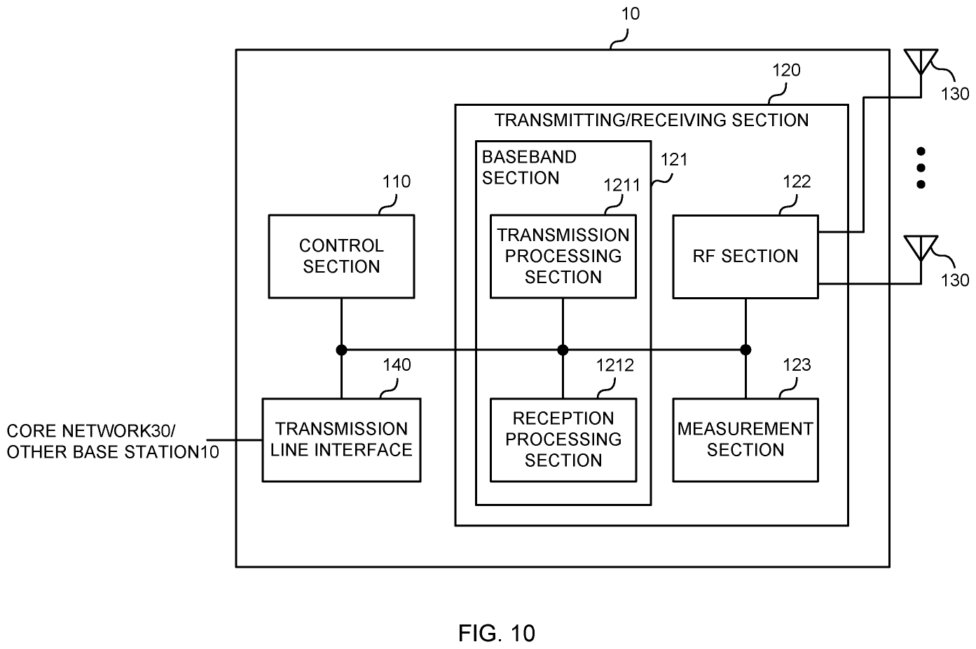

FIG. 10 is a diagram illustrating an example of a configuration of a base station according to one embodiment. The base station 10 includes a control section 110, a transmitting/receiving section 120, a transmission/reception antenna 130, and a transmission line interface 140. Note that one or more of the control sections 110, one or more of the transmitting/receiving sections 120, one or more of the transmission/reception antennas 130, and one or more of the transmission line interfaces 140 may be included.

Note that this example mainly describes a functional block which is a characteristic part of the present embodiment, and it may be assumed that the base station 10 also has another functional block necessary for radio communication. A part of processing of each section described below may be omitted.

The control section 110 controls the entire base station 10. The control section 110 can be constituted by a controller, a control circuit, or the like, which is described based on common recognition in the technical field to which the present disclosure relates.

The control section 110 may control signal generation, scheduling (for example, resource allocation or mapping), and the like. The control section 110 may control transmission/reception, measurement, and the like using the transmitting/receiving section 120, the transmission/reception antenna 130, and the transmission line interface 140. The control section 110 may generate data to be transmitted as a signal, control information, a sequence, and the like, and may forward the data, the control information, the sequence, and the like to the transmitting/receiving section 120. The control section 110 may perform call processing (such as configuration or releasing) of a communication channel, management of the state of the base station 10, and management of a radio resource.

The transmitting/receiving section 120 may include a baseband section 121, a radio frequency (RF) section 122, and a measurement section 123. The baseband section 121 may include a transmission processing section 1211 and a reception processing section 1212. The transmitting/receiving section 120 can include a transmitter/receiver, an RF circuit, a baseband circuit, a filter, a phase shifter, a measurement circuit, a transmission/reception circuit, and the like that are described on the basis of common recognition in the technical field related to the present disclosure.

The transmitting/receiving section 120 may be configured as an integrated transmitting/receiving section, or may be configured by a transmitting section and a receiving section. The transmitting section may include the transmission processing section 1211 and the RF section 122. The receiving section may be constituted by the reception processing section 1212, the RF section 122, and the measurement section 123.

The transmission/reception antenna 130 can include an antenna described based on common recognition in the technical field to which the present disclosure relates, for example, an array antenna or the like.

The transmitting/receiving section 120 may transmit the above-described downlink channel, synchronization signal, downlink reference signal, and the like. The transmitting/receiving section 120 may receive the above-described uplink channel, uplink reference signal, and the like.

The transmitting/receiving section 120 may form at least one of a transmission beam and a reception beam by using digital beam forming (for example, precoding), analog beam forming (for example, phase rotation), and the like.

The transmitting/receiving section 120 (transmission processing section 1211) may perform packet data convergence protocol (PDCP) layer processing, radio link control (RLC) layer processing (for example, RLC retransmission control), medium access control (MAC) layer processing (for example, HARQ retransmission control), and the like on, for example, data, control information, and the like acquired from the control section 110, to generate a bit string to be transmitted.

The transmitting/receiving section 120 (transmission processing section 1211) may perform transmission processing such as channel encoding (which may include error correction encoding), modulation, mapping, filtering processing, discrete Fourier transform (DFT) processing (if necessary), inverse fast Fourier transform (IFFT) processing, precoding, or digital-analog conversion on the bit string to be transmitted, to output a baseband signal.

The transmitting/receiving section 120 (RF section 122) may perform modulation to a radio frequency band, filtering processing, amplification, and the like on the baseband signal, and may transmit a signal in the radio frequency band via the transmission/reception antenna 130. Meanwhile, the transmitting/receiving section 120 (RF section 122) may perform amplification, filtering processing, demodulation to a baseband signal, and the like on the signal in the radio frequency band received by the transmission/reception antenna 130.

The transmitting/receiving section 120 (reception processing section 1212) may apply reception processing such as analog-digital conversion, fast Fourier transform (FFT) processing, inverse discrete Fourier transform (IDFT) processing (if necessary), filtering processing, demapping, demodulation, decoding (which may include error correction decoding), MAC layer processing, RLC layer processing, or PDCP layer processing on the acquired baseband signal, to acquire user data and the like.

The transmitting/receiving section 120 (measurement section 123) may perform measurement on the received signal. For example, the measurement section 123 may perform radio resource management (RRM), channel state information (CSI) measurement, and the like based on the received signal. The measurement section 123 may measure received power (for example, reference signal received power (RSRP)), received quality (for example, reference signal received quality (RSRQ), a signal to interference plus noise ratio (SINR), a signal to noise ratio (SNR)), signal strength (for example, received signal strength indicator (RSSI)), propagation path information (for example, CSI), and the like. The measurement result may be output to the control section 110.

The transmission line interface 140 may transmit/receive a signal (backhaul signaling) to and from an apparatus included in the core network 30, another base stations 10, and the like, and may acquire, transmit, and the like user data (user plane data), control plane data, and the like for the user terminal 20.

Note that the transmitting section and the receiving section of the base station 10 in the present disclosure may include at least one of the transmitting/receiving section 120, the transmission/reception antenna 130, and the transmission line interface 140.

The transmitting/receiving section 120 may transmit information regarding a detection unit of a beam failure corresponding to each of one or more cells.

The control section 110 may control reception of a medium access control control element (MAC CE) including a field indicating a beam failure in a cell unit or a transmission/reception point at which a beam failure is detected based on the detection unit of the beam failure of a corresponding cell.

### (User Terminal)

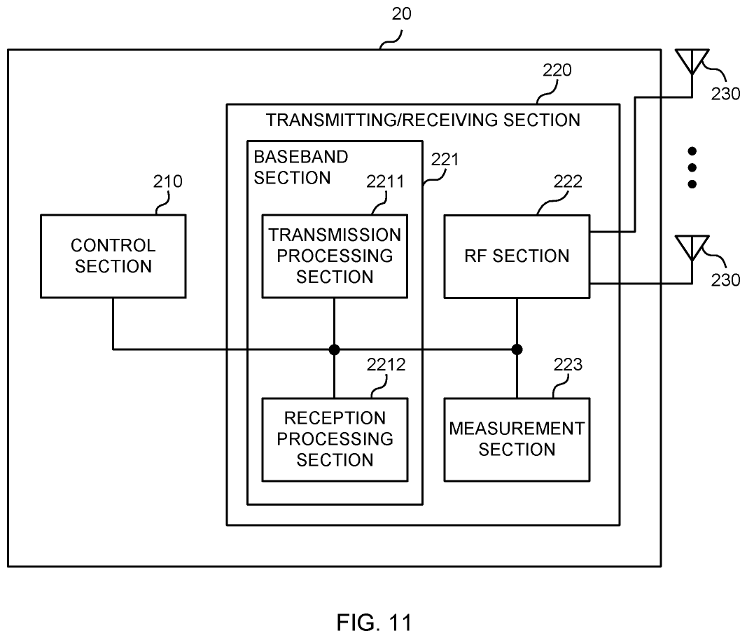

FIG. 11 is a diagram illustrating an example of a configuration of user terminal according to one embodiment. The user terminal 20 includes a control section 210, a transmitting/receiving section 220, and a transmission/reception antenna 230. Note that one or more of the control sections 210, one or more of the transmitting/receiving sections 220, and one or more of the transmission/reception antennas 230 may be included.

Note that, although this example mainly describes functional blocks of a characteristic part of the present embodiment, it may be assumed that the user terminal 20 includes other functional blocks that are necessary for radio communication as well. A part of processing of each section described below may be omitted.

The control section 210 controls the entire user terminal 20. The control section 210 can include a controller, a control circuit, and the like that are described based on common recognition in the technical field related to the present disclosure.

The control section 210 may control signal generation, mapping, and the like. The control section 210 may control transmission/reception, measurement, and the like using the transmitting/receiving section 220 and the transmission/reception antenna 230. The control section 210 may generate data, control information, a sequence, and the like to be transmitted as signals, and may forward the data, control information, sequence, and the like to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be implemented by a transmitter/receiver, an RF circuit, a baseband circuit, a filter, a phase shifter, a measurement circuit, a transmitting/receiving circuit, and the like that are described based on common recognition in the technical field related to the present disclosure.

The transmitting/receiving section 220 may be formed as an integrated transmitting/receiving section, or may include a transmitting section and a receiving section. The transmitting section may include the transmission processing section 2211 and the RF section 222. The receiving section may include the reception processing section 2212, the RF section 222, and the measurement section 223.

The transmission/reception antenna 230 can include an antenna described based on common recognition in the technical field to which the present disclosure relates, for example, an array antenna or the like.

The transmitting/receiving section 220 may receive the above-described downlink channel, synchronization signal, downlink reference signal, and the like. The transmitting/receiving section 220 may transmit the above-described uplink channel, uplink reference signal, and the like.

The transmitting/receiving section 220 may form at least one of a transmission beam or a reception beam by using digital beam forming (for example, precoding), analog beam forming (for example, phase rotation), and the like.

The transmitting/receiving section 220 (transmission processing section 2211) may perform PDCP layer processing, RLC layer processing (for example, RLC retransmission control), MAC layer processing (for example, HARQ retransmission control), and the like on, for example, data, control information, and the like acquired from the control section 210, to generate a bit string to be transmitted.

The transmitting/receiving section 220 (transmission processing section 2211) may perform transmission processing such as channel encoding (which may include error correction encoding), modulation, mapping, filtering processing, DFT processing (if necessary), IFFT processing, precoding, or digital-analog conversion on the bit string to be transmitted, to output a baseband signal.

Note that whether or not to apply DFT processing may be determined based on configuration of transform precoding. When the transform precoding is enabled for a channel (for example, PUSCH), the transmitting/receiving section 220 (transmission processing section 2211) may perform DFT processing as the transmission processing to transmit the channel by using a DFT-s-OFDM waveform, and when not, DFT processing does not have to be performed as the transmission processing.

The transmitting/receiving section 220 (RF section 222) may perform modulation to a radio frequency band, filtering processing, amplification, and the like on the baseband signal, to transmit a signal in the radio frequency band via the transmission/reception antenna 230.

Meanwhile, the transmitting/receiving section 220 (RF section 222) may perform amplification, filtering processing, demodulation to a baseband signal, and the like on the signal in the radio frequency band received by the transmission/reception antenna 230.

The transmitting/receiving section 220 (reception processing section 2212) may apply reception processing such as analog-digital conversion, FFT processing, IDFT processing (if necessary), filtering processing, demapping, demodulation, decoding (which may include error correction decoding), MAC layer processing, RLC layer processing, or PDCP layer processing on the acquired baseband signal, to acquire user data and the like.

The transmitting/receiving section 220 (measurement section 223) may perform measurement on the received signal. For example, the measurement section 223 may perform RRM measurement, CSI measurement, and the like based on the received signal. The measurement section 223 may measure received power (for example, RSRP), received quality (for example, RSRQ, SINR, or SNR), signal strength (for example, RSSI), propagation path information (for example, CSI), and the like. The measurement result may be output to the control section 210.

Note that the transmitting section and the receiving section of the user terminal 20 in the present disclosure may include at least one of the transmitting/receiving section 220 or the transmission/reception antenna 230.

The transmitting/receiving section 220 may receive information regarding a detection unit of a beam failure corresponding to each of one or more cells.

The control section 210 may control transmission of a medium access control control element (MAC CE) including a field indicating a beam failure in a cell unit or a transmission/reception point at which a beam failure is detected based on the detection unit of the beam failure of a corresponding cell.

The control section 210 may determine the number of octets used for notification of an index of a candidate reference signal based on at least one of the detection unit of the beam failure of the cell and the number of transmission/reception points at which the beam failure is detected.

The MAC CE may not include a field for cell index notification.

In a case where the beam failure in units of transmission/reception points is applied to a specific cell, the control section 210 may perform control to transmit information regarding the transmission/reception point at which the beam failure is detected, the information being included in at least one of a random access preamble or a MAC CE in a random access procedure.

### (Hardware Configuration)

Note that the block diagrams that have been used to describe the above embodiments illustrate blocks in functional units. These functional blocks (components) may be implemented in arbitrary combinations of at least one of hardware or software. Further, the method for implementing each functional block is not particularly limited. That is, each functional block may be implemented by a single apparatus physically or logically aggregated, or may be implemented by directly or indirectly connecting two or more physically or logically separate apparatuses (in a wired manner, a radio manner, or the like, for example) and using these plural apparatuses. The functional block may be implemented by combining the one apparatus or the plurality of apparatuses with software.

Here, the function includes, but is not limited to, determining, judging, calculating, computing, processing, deriving, investigating, searching, ascertaining, receiving, transmitting, outputting, accessing, solving, selecting, choosing, establishing, comparing, assuming, expecting, regarding, broadcasting, notifying, communicating, forwarding, configuring, reconfiguring, allocating, mapping, assigning, and the like. For example, a functional block (component) that has a transmission function may be referred to as a transmitting section (transmitting unit), a transmitter, and the like. In any case, as described above, the implementation method is not particularly limited.

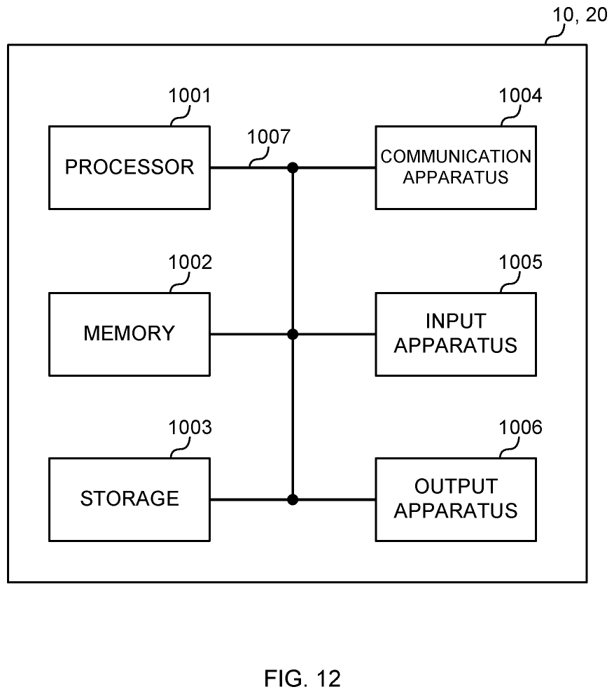

For example, the base station, the user terminal, and the like according to one embodiment of the present disclosure may function as a computer that executes the processing of the radio communication method of the present disclosure. FIG. 12 is a diagram illustrating an example of a hardware configuration of the base station and the user terminal according to one embodiment. Physically, the above-described base station 10 and user terminal 20 may be formed as a computer apparatus that includes a processor 1001, a memory 1002, a storage 1003, a communication apparatus 1004, an input apparatus 1005, an output apparatus 1006, a bus 1007, and the like.

Note that in the present disclosure, the terms such as an apparatus, a circuit, a device, a section, or a unit can be replaced with each other. The hardware configuration of the base station 10 and the user terminal 20 may be designed to include one or more of the apparatuses illustrated in the drawings, or may be designed not to include some apparatuses.

For example, although only one processor 1001 is illustrated, a plurality of processors may be provided. Further, the processing may be executed by one processor, or the processing may be executed by two or more processors simultaneously or sequentially, or using other methods. Note that the processor 1001 may be implemented with one or more chips.

Each function of the base station 10 and the user terminal 20 is implemented by, for example, predetermined software (program) being read on hardware such as the processor 1001 and the memory 1002, by which the processor 1001 performs operations, controlling communication via the communication apparatus 1004, and controlling at least one of reading or writing of data at the memory 1002 and the storage 1003.

The processor 1001 may control the whole computer by, for example, running an operating system. The processor 1001 may be implemented by a central processing unit (CPU) including an interface with peripheral equipment, a control apparatus, an operation apparatus, a register, and the like. For example, at least a part of the above-described control section 110 (210), transmitting/receiving section 120 (220), and the like may be implemented by the processor 1001.

Further, the processor 1001 reads programs (program codes), software modules, data, and the like from at least one of the storage 1003 or the communication apparatus 1004 into the memory 1002, and performs various types of processing according to these. As the program, a program that causes a computer to execute at least a part of the operation described in the above-described embodiment is used. For example, the control section 110 (210) may be implemented by control programs that are stored in the memory 1002 and that operate on the processor 1001, and other functional blocks may be similarly implemented.

The memory 1002 is a computer-readable recording medium, and may include, for example, at least one of a read only memory (ROM), an erasable programmable ROM (EPROM), an electrically EPROM (EEPROM), a random access memory (RAM), or other appropriate storage media. The memory 1002 may be referred to as a register, a cache, a main memory (primary storage apparatus), and the like. The memory 1002 can store programs (program codes), software modules, and the like that are executable for implementing the radio communication method according to one embodiment of the present disclosure.

The storage 1003 is a computer-readable recording medium, and may include, for example, at least one of a flexible disk, a floppy (registered trademark) disk, a magneto-optical disk (for example, a compact disc ROM (CD-ROM) and the like), a digital versatile disk, a Blu-ray (registered trademark) disk), a removable disk, a hard disk drive, a smart card, a flash memory device (for example, a card, a stick, or a key drive), a magnetic stripe, a database, a server, or other appropriate storage media. The storage 1003 may be referred to as “secondary storage apparatus”.

The communication apparatus 1004 is hardware (transmission/reception device) for performing inter-computer communication via at least one of a wired network or a wireless network, and is referred to as, for example, a network device, a network controller, a network card, a communication module, and the like. The communication apparatus 1004 may include a high frequency switch, a duplexer, a filter, a frequency synthesizer, and the like in order to implement, for example, at least one of frequency division duplex (FDD) or time division duplex (TDD). For example, the transmitting/receiving section 120 (220), the transmission/reception antenna 130 (230), and the like described above may be implemented by the communication apparatus 1004. The transmitting/receiving section 120 (220) may be implemented by being physically or logically separated into the transmitting section 120a (220a) and the receiving section 120b (220b).

The input apparatus 1005 is an input device for receiving input from the outside (for example, a keyboard, a mouse, a microphone, a switch, a button, a sensor and so on). The output apparatus 1006 is an output device that performs output to the outside (for example, a display, a speaker, a light emitting diode (LED) lamp, or the like). Note that the input apparatus 1005 and the output apparatus 1006 may be provided in an integrated structure (for example, a touch panel).

Furthermore, these pieces of apparatus, including the processor 1001, the memory 1002 and so on are connected by the bus 1007 so as to communicate information. The bus 1007 may be formed with a single bus, or may be formed with buses that vary between pieces of apparatus.

Further, the base station 10 and the user terminal 20 may include hardware such as a microprocessor, a digital signal processor (DSP), an application specific integrated circuit (ASIC), a programmable logic device (PLD), or a field programmable gate array (FPGA), and some or all of the functional blocks may be implemented by using the hardware. For example, the processor 1001 may be implemented with at least one of these pieces of hardware.

### Modifications

Note that terms described in the present disclosure and terms necessary for understanding the present disclosure may be replaced with terms that have the same or similar meanings. For example, a channel, a symbol, and a signal (signal or signaling) may be replaced with each other. Further, the signal may be a message. The reference signal can be abbreviated as an RS, and may be referred to as a pilot, a pilot signal, and the like, depending on which standard applies. Further, a component carrier (CC) may be referred to as a cell, a frequency carrier, a carrier frequency, and the like.

A radio frame may include one or more periods (frames) in the time domain. Each of the one or more periods (frames) included in the radio frame may be referred to as a subframe. Further, the subframe may include one or more slots in the time domain. The subframe may be a fixed duration (for example, 1 ms) that is not dependent on numerology.

Here, the numerology may be a communication parameter used for at least one of transmission or reception of a certain signal or channel. For example, the numerology may indicate at least one of subcarrier spacing (SCS), a bandwidth, a symbol length, a cyclic prefix length, a transmission time interval (TTI), the number of symbols per TTI, a radio frame configuration, specific filtering processing performed by a transceiver in the frequency domain, specific windowing processing performed by a transceiver in the time domain, or the like.

The slot may include one or more symbols in the time domain (orthogonal frequency division multiplexing (OFDM) symbols, single carrier frequency division multiple access (SC-FDMA) symbols, and the like). In addition, a slot may be a time unit based on numerology.

The slot may include a plurality of mini slots. Each mini slot may include one or more symbols in the time domain. Further, the mini slot may be referred to as a subslot. Each mini slot may include fewer symbols than the slot. A PDSCH (or PUSCH) transmitted in a time unit larger than the mini slot may be referred to as “PDSCH (PUSCH) mapping type A”. A PDSCH (or PUSCH) transmitted using a mini slot may be referred to as PDSCH (PUSCH) mapping type B.

A radio frame, a subframe, a slot, a mini slot and a symbol all represent the time unit in signal communication. The radio frame, the subframe, the slot, the mini slot, and the symbol may be called by other applicable names, respectively. Note that time units such as the frame, the subframe, the slot, the mini slot, and the symbol in the present disclosure may be replaced with each other.

For example, one subframe may be referred to as TTI, a plurality of consecutive subframes may be referred to as TTI, or one slot or one mini slot may be referred to as TTI. That is, at least one of the subframe or the TTI may be a subframe (1 ms) in the existing LTE, may be a period shorter than 1 ms (for example, one to thirteen symbols), or may be a period longer than 1 ms. Note that the unit to represent the TTI may be referred to as a “slot,” a “mini slot” and so on, instead of a “subframe”.

Here, a TTI refers to the minimum time unit of scheduling in radio communication, for example. For example, in the LTE system, a base station performs scheduling to allocate radio resources (a frequency bandwidth, transmission power, and the like that can be used in each user terminal) to each user terminal in TTI units. Note that the definition of TTIs is not limited to this.

The TTI may be a transmission time unit of a channel-coded data packet (transport block), a code block, a codeword, and the like or may be a processing unit of scheduling, link adaptation, and the like Note that, when the TTI is given, a time interval (for example, the number of symbols) to which a transport block, a code block, a codeword, or the like is actually mapped may be shorter than the TTI.

Note that, when one slot or one mini slot is referred to as a “TTI,” one or more TTIs (that is, one or multiple slots or one or more mini slots) may be the minimum time unit of scheduling. Further, the number of slots (the number of mini slots) to constitute this minimum time unit of scheduling may be controlled.

A TTI having a duration of 1 ms may be referred to as a usual TTI (TTI in 3GPP Rel. 8 to 12), a normal TTI, a long TTI, a usual subframe, a normal subframe, a long subframe, a slot, or the like. A TTI that is shorter than the usual TTI may be referred to as a shortened TTI, a short TTI, a partial TTI (or fractional TTI), a shortened subframe, a short subframe, a mini slot, a subslot, a slot, or the like.

Note that a long TTI (for example, a normal TTI, a subframe, and the like) may be replaced with a TTI having a time duration exceeding 1 ms, and a short TTI (for example, a shortened TTI) may be replaced with a TTI having a TTI duration less than the TTI duration of a long TTI and not less than 1 ms.

A resource block (RB) is the unit of resource allocation in the time domain and the frequency domain, and may include one or more contiguous subcarriers in the frequency domain. The number of subcarriers included in the RB may be the same regardless of the numerology, and may be twelve, for example. The number of subcarriers included in the RB may be determined based on a numerology.

In addition, an RB may include one or more symbols in the time domain, and may be one slot, one mini slot, one subframe or one TTI in length. One TTI, one subframe, and the like may each be constituted by of one or more resource blocks.

Note that one or more RBs may be referred to as a physical resource block (PRB), a sub-carrier group (SCG), a resource element group (REG), a PRB pair, an RB pair, and the like.

Furthermore, a resource block may include one or more resource elements (REs). For example, one RE may be a radio resource field of one subcarrier and one symbol.

A bandwidth part (BWP) (which may be referred to as a partial bandwidth or the like) may represent a subset of contiguous common resource blocks (RBs) for a certain numerology in a certain carrier. Here, the common RB may be specified by the index of the RB based on a common reference point of the carrier. The PRB may be defined in a BWP and numbered within the BWP.

The BWP may include a BWP for UL (UL BWP) and a BWP for DL (DL BWP). For the UE, one or more BWPs may be configured within one carrier.

At least one of the configured BWPs may be active, and the UE does not have to expect transmission/reception of a predetermined signal/channel outside the active BWP. Note that “cell”, “carrier”, and the like in the present disclosure may be replaced with “BWP”.

Note that the structures of radio frames, subframes, slots, mini slots, symbols and so on described above are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, the symbol length, the length of cyclic prefix (CP), and the like can be variously changed.

Further, the information, parameters, and the like described in the present disclosure may be represented in absolute values or in relative values with respect to given values, or may be represented using other applicable information. For example, a radio resource may be indicated by a predetermined index.

The names used for parameters and the like in the present disclosure are in no respect limiting. Further, any mathematical expression or the like that uses these parameters may differ from those explicitly disclosed in the present disclosure. Since various channels (PUCCH, PDCCH, and the like) and information elements can be identified by any suitable names, various names allocated to these various channels and information elements are not restrictive names in any respect.

The information, signals, and the like described in the present disclosure may be represented using any of a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Further, information, signals, and the like can be output in at least one of a direction from higher layers to lower layers and a direction from lower layers to higher layers. Information, signals and so on may be input and output via a plurality of network nodes.

The information, signals and so on that are input and/or output may be stored in a specific location (for example, in a memory), or may be managed in a control table. The information, signals, and the like to be input and output can be overwritten, updated, or appended. The output information, signals, and the like may be deleted. The information, signals and so on that are input may be transmitted to other pieces of apparatus.

Notification of information may be performed not only by using the aspects/embodiments described in the present disclosure but also using another method. For example, the notification of information in the present disclosure may be performed by using physical layer signaling (for example, downlink control information (DCI) or uplink control information (UCI)), higher layer signaling (for example, radio resource control (RRC) signaling, broadcast information (master information block (MIB)), system information block (SIB), or the like), or medium access control (MAC) signaling), another signal, or a combination thereof.

Note that the physical layer signaling may be referred to as Layer 1/Layer 2 (L1/L2) control information (L1/L2 control signal), L1 control information (L1 control signal), and the like. Further, the RRC signaling may be referred to as an RRC message, and may be, for example, an RRC connection setup message, an RRC connection reconfiguration message, and the like. Further, notification of the MAC signaling may be performed using, for example, an MAC control element (CE).

In addition, notification of predetermined information (for example, notification of “being X”) is not limited to explicit notification, and may be performed implicitly (for example, by not giving a notification of the predetermined information or by giving a notification of another information,).

Decisions may be made in values represented by one bit (0 or 1), may be made in Boolean values that represent true or false, or may be made by comparing numerical values (for example, comparison against a given value).

Software, whether referred to as software, firmware, middleware, microcode or hardware description language, or called by other names, should be interpreted broadly, to mean instructions, instruction sets, code, code segments, program codes, programs, subprograms, software modules, applications, software applications, software packages, routines, subroutines, objects, executable files, execution threads, procedures, functions and so on.

Moreover, software, commands, information, and the like may be transmitted and received via communication media. For example, when software is transmitted from a website, a server, or another remote source by using at least one of a wired technology (coaxial cable, optical fiber cable, twisted pair, digital subscriber line (DSL), or the like) or a wireless technology (infrared rays, microwaves, and the like), at least one of the wired technology or the wireless technology is included within the definition of a transmission medium.

The terms “system” and “network” used in the present disclosure may be used interchangeably. The “network” may mean an apparatus (for example, a base station) included in the network.

In the present disclosure, terms such as “precoding”, “precoder”, “weight (precoding weight)”, “quasi-co-location (QCL)”, “transmission configuration indication state (TCI state)”, “spatial relation”, “spatial domain filter”, “transmission power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” may be used interchangeably.

In the present disclosure, terms such as “base station (BS)”, “radio base station”, “fixed station”, “NodeB”, “eNodeB (eNB)”, “gNodeB (gNB)”, “access point”, “transmission point (TP)”, “reception point (RP)”, “transmission/reception point (TRP)”, “panel”, “cell”, “sector”, “cell group”, “carrier”, and “component carrier”, may be used interchangeably. The base station may be referred to as a term such as a macro cell, a small cell, a femto cell, or a pico cell.

The base station can accommodate one or more (for example, three) cells. In a case where the base station accommodates a plurality of cells, the entire coverage area of the base station can be partitioned into a plurality of smaller areas, and each smaller area can provide communication services through a base station subsystem (for example, small base station for indoors (remote radio head (RRH))). The term “cell” or “sector” refers to a part or the whole of a coverage area of at least one of the base station or the base station subsystem that performs a communication service in this coverage.

In the present disclosure, the terms such as “mobile station (MS)”, “user terminal”, “user equipment (UE)”, and “terminal” may be used interchangeably.

The mobile station may be referred to as a subscriber station, mobile unit, subscriber station, wireless unit, remote unit, mobile device, wireless device, wireless communication device, remote device, mobile subscriber station, access terminal, mobile terminal, wireless terminal, remote terminal, handset, user agent, mobile client, client, or some other suitable terms.

At least one of the base station or the mobile station may be called as a transmitting apparatus, a receiving apparatus, a radio communication apparatus, and the like. Note that at least one of the base station or the mobile station may be a device mounted on a moving object, a moving objet itself, and the like. The moving object may be a transportation (for example, a car, an airplane, or the like), an unmanned moving object (for example, a drone, an automated car, or the like), or a (manned or unmanned) robot. Note that at least one of the base station and the mobile station also includes a device that does not necessarily move during a communication operation. For example, at least one of the base station or the mobile station may be an Internet of Things (IoT) device such as a sensor.

Further, the base station in the present disclosure may be replaced with the user terminal. For example, each aspect/embodiment of the present disclosure may be applied to a configuration in which communication between the base station and the user terminal is replaced with communication among a plurality of user terminals (which may be referred to as, for example, device-to-device (D2D), vehicle-to-everything (V2X), and the like). In this case, the user terminal 20 may have the function of the above-described base station 10. In addition, terms such as “uplink” and “downlink” may be replaced with words corresponding to terminal-to-terminal communication (for example, “side link”). For example, an uplink channel, a downlink channel, and the like may be replaced with a side link channel.

Similarly, a user terminal in the present disclosure may be replaced with a base station. In this case, the base station 10 may have the functions of the user terminal 20 described above.

In the present disclosure, an operation performed by the base station may be performed by an upper node thereof in some cases. In a network including one or more network nodes with base stations, it is clear that various operations performed for communication with a terminal can be performed by a base station, one or more network nodes (examples of which include but are not limited to mobility management entity (MME) and serving-gateway (S-GW)) other than the base station, or a combination thereof.

The aspects/embodiments illustrated in the present disclosure may be used individually or in combinations, which may be switched depending on the mode of implementation. Further, the order of processing procedures, sequences, flowcharts, and the like of the aspects/embodiments described in the present disclosure may be re-ordered as long as there is no inconsistency. For example, the methods described in the present disclosure have presented various step elements using an exemplary order, and are not limited to the presented specific order.

Each aspect/embodiment described in the present disclosure may be applied to a system using long term evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG) (xG (x is, for example, an integer or decimal)), future radio access (FRA), new radio access technology (RAT), new radio (NR), new radio access (NX), future generation radio access (FX), global system for mobile communications (GSM (registered trademark)), CDMA2000, ultra mobile broadband (UMB), IEEE 802.11 (Wi-Fi (registered trademark)), IEEE 802.16 (WiMAX (registered trademark)), IEEE 802.20, Ultra-Wide Band (UWB), Bluetooth (registered trademark), or another appropriate radio communication method, a next generation system expanded based on these, and the like. Further, a plurality of systems may be combined and applied (for example, a combination of LTE or LTE-A and 5G, and the like).

The phrase “based on” as used in the present disclosure does not mean “based only on”, unless otherwise specified. In other words, the phrase “based on” means both “based only on” and “based at least on”.

All references to the elements using designations such as “first” and “second” as used in the present disclosure do not generally limit the amount or sequence of these elements. These designations can be used in the present disclosure, as a convenient way of distinguishing between two or more elements. In this way, reference to the first and second elements does not imply that only two elements may be employed, or that the first element must precede the second element in some way.

The term “determining” as used in the present disclosure may include a wide variety of operations. For example, “determining” may be regarded as “determining” judging, calculating, computing, processing, deriving, investigating, looking up (or searching or inquiring) (for example, looking up in a table, database, or another data structure), ascertaining, and the like.

Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on.

In addition, to “judge” and “determine” as used herein may be interpreted to mean making judgements and determinations related to resolving, selecting, choosing, establishing, comparing and so on. In other words, to “judge” and “determine” as used herein may be interpreted to mean making judgements and determinations related to some action.

In addition, “determining” may be replaced with “assuming”, “expecting”, “considering”, or the like. The “maximum transmission power” described in the present disclosure may mean a maximum value of transmission power, nominal UE maximum transmit power, or rated UE maximum transmit power.

As used in the present disclosure, the terms “connected” and “coupled”, or any variation of these terms mean all direct or indirect connections or couplings between two or more elements, and may include the presence of one or more intermediate elements between two elements that are “connected” or “coupled” to each other. The coupling or connection between the elements may be physical, logical, or a combination of these. For example, “connection” may be replaced with “access”.

In the present disclosure, when two elements are connected together, it is conceivable that the two elements are “connected” or “coupled” to each other by using one or more electrical wires, cables, printed electrical connections, and the like, and, as some non-limiting and non-inclusive examples, by using electromagnetic energy having wavelengths in the radio frequency domain, microwave region, or optical (both visible and invisible) region, or the like.

In the present disclosure, a term “A and B are different” may mean “A and B are different from each other”. Note that the phrase may mean that “A and B are different from C”. The terms such as “separated”, “coupled”, and the like may be interpreted as “different”.

When “include”, “including”, and variations of these are used in the present disclosure, these terms are intended to be inclusive similarly to the term “comprising”. Furthermore, the term “or” as used in the present disclosure is intended to be not an exclusive-OR.

In the present disclosure, for example, in a case where translations add articles such as a, an, and the in English, the present disclosure may include that the noun that follows these articles is in the plural.

Although the invention according to the present disclosure has been described in detail above, it is obvious to a person skilled in the art that the invention according to the present disclosure is not limited to the embodiments described in the present disclosure. The invention according to the present disclosure can be implemented with various corrections and in various modifications, without departing from the spirit and scope of the invention defined by the recitations of claims. Thus, the description of the present disclosure is for the purpose of explaining examples and does not bring any limiting meaning to the invention according to the present disclosure.

This application is based on Japanese Patent Application No. 2021-135503 filed on Aug. 23, 2021. The contents of this are all incorporated herein.

1. A terminal, comprising:
a receiving section that receives information regarding a detection unit of a beam failure corresponding to each of one or more cells; and
a control section that controls transmission of a medium access control control element (MAC CE) including a field indicating a beam failure in a cell unit or a transmission/reception point at which a beam failure is detected based on the detection unit of the beam failure of a corresponding cell.

2. The terminal according to claim 1, wherein the control section determines a number of octets used for notification of an index of a candidate reference signal based on at least one of the detection unit of the beam failure of a cell and a number of transmission/reception points at which the beam failure is detected.

3. The terminal according to claim 1, wherein the MAC CE does not include a field for cell index notification.

4. The terminal according to claim 1, wherein in a case where the beam failure in units of transmission/reception points is applied to a specific cell, the control section transmits information regarding the transmission/reception point at which the beam failure is detected, the information being included in at least one of a random access preamble or a MAC CE in a random access procedure.

5. A radio communication method of a terminal, the method comprising:
a step of receiving information regarding a detection unit of a beam failure corresponding to each of one or more cells; and
a step of controlling transmission of a medium access control control element (MAC CE) including a field indicating a beam failure in a cell unit or a transmission/reception point at which a beam failure is detected based on the detection unit of the beam failure of a corresponding cell.

6. A base station, comprising:
a transmitting section that transmits information regarding a detection unit of a beam failure corresponding to each of one or more cells; and
a control section that controls reception of a medium access control control element (MAC CE) including a field indicating a beam failure in a cell unit or a transmission/reception point at which a beam failure is detected based on the detection unit of the beam failure of a corresponding cell.

7. The terminal according to claim 2, wherein the MAC CE does not include a field for cell index notification.

8. The terminal according to claim 2, wherein in a case where the beam failure in units of transmission/reception points is applied to a specific cell, the control section transmits information regarding the transmission/reception point at which the beam failure is detected, the information being included in at least one of a random access preamble or a MAC CE in a random access procedure.

9. The terminal according to claim 3, wherein in a case where the beam failure in units of transmission/reception points is applied to a specific cell, the control section transmits information regarding the transmission/reception point at which the beam failure is detected, the information being included in at least one of a random access preamble or a MAC CE in a random access procedure.
